(19) United States
(12) Patent Application Publication
(10) Pub. No.: US 2003/0046426 A1
(43) Pub. Date: Mar. 6, 2003

(54) Real time traffic engineering of data-networks

(76) Inventor: Luc Nguyen, Atlanta, GA (US)

Correspondence Address: Kirk W. GOODWIN, MORRIS, MANNING & MARTIN, LLP, 1600 Atlanta Financial Center, 33343 Peahtree Road, N.E., Atlanta, GA, 30326, US

(21) Appl. No.: 09/970,448

(22) Filed: Oct. 2, 2001

Related U.S. Application Data
(60) Provisional application No. 60/237,320, filed on Oct. 2, 2000.

(51) Int. Cl. G06F 15/173; G06F 15/16

(52) U.S. Cl. 709/242; 709/224

(57) ABSTRACT

A method and system of providing for central control and intelligent routing of data network traffic where a server is operatively connected to a network and is capable of receiving information regarding network status, specifically capable of recognizing network congestion, formulating a solution to the network congestion and re-configure network traffic to reroute around network congestion.

### PRIORITY CLAIMED

The present application seeks to claim benefit to earlier filed patent application Serial No. 60/237,320, filed on Oct. 2, 2000, and titled “Process for Real Time Traffic Engineering of Data Networks” on behalf of Luc.

### TECHNICAL FIELD

The present invention relates generally to digital data traffic, and relates more specifically to routing of digital data traffic with a centralized control and real-time or near real-time routing.

### BACKGROUND OF THE INVENTION

The Internet is growing at exponential rates. Competition is coming from both traditional service providers and unconventional but well funded startups. As one skilled in the art is aware, the Internet was designed as a DARPA project in the 1950's. The distributed routing architecture allowed it to function in case of nuclear disaster or other catastrophic events to the network. This best effort routing has served us well for its intended purposes. As customers started to rely on the Internet for their mainstream businesses, this technology became inadequate.

Traffic in a Data Communications Network, especially the Internet, is in general served with the best effort as discussed above. In essence, the traffic is not guaranteed, and will be served if there is enough resource. In networks with technologies like Asynchronous Transfer Mode (ATM) and Frame Relay, specific paths can be configured and engineered to serve the traffic demands. They are largely static and will not change for the life of the planning periods, which can be many years.

In all Data Networks, the path for each traffic demand is generally static, except the cases of failure in certain network components. A path is typically considered to be a set of connected arcs between two nodes in a network. Arcs are typically viewed as a logical one-way connection on a link. A link, therefore, consists of two logical arcs wherein one is in each direction.

In those cases, methods are in place to automatically reroute traffic on different paths. Network Congestion affects traffic and network performance but is not a criterion for traffic to be rerouted. In case of congestion, traffic is generally queued up inside switches, routers, or other network components and waits for the congestion event to clear. The waiting affects the performance of many types of network traffic such as Voice and Video. In addition, this congestion is largely contained in a local area affecting only a small numbers of network components. The rest of the network is largely unaffected and under-utilized, thus creating at times, an unbalanced network.

Network Congestions are unpredictable and can last from a few minutes to many hours and even many days, usually during busy hours. They can affect a different part of the network each time. Manual interventions to head-off or relieve congestions have not been very effective or consistent.

In spite of that, service providers today are entering into contracts with their largest customers in the form of Service Level Agreements (SLAs) promising better services for their business.

SLAs typically guarantee a certain level of service. Failing that the customers either receive a refund, do not have to pay, or even receive a penalty payback from the service providers. These are costs for the service providers. Current technologies do not offer a method to enforce these guarantees. Network failures and congestion are common due to unpredictability of the traffic. The service providers are typically overbuilding their networks to ensure theSLAs can be met. This approach is costly and still does not provide the adequate assurance that the SLAs can really be met. SLA's have become legal contracts with no way to technically enforce them.

Therefore, the need for an efficient and flexible system to automatically control and reroute data traffic in case of congestions clearly exists. The system will improve network performance, balance the traffic load, and increase the efficiency of the existing network infrastructure.

### SUMMARY OF THE INVENTION

As discussed above, the present invention converts business profiles and objectives into network constraints, optimizes the traffic routing based on these constraints to balance the load over the entire network. These functionalities provide solutions to many critical problems for the service providers. These Problems include such issues as network design, network performance, network availability, network planning, traffic engineering, and maximizing business objectives using existing network resources.

The present invention provides a system and method for Centralized Control and Intelligent Routing of Data Communications Traffic in Real Time or Near Real Time. This system is therefore capable in assisting meeting network demands through intelligent routing.

A demand, in this present application here forward is defined as the requirement for a certain amount of bandwidth to be reserved between an originating and a terminating node in a network. A node in a network, in turn, is defined as a switch, router, or other such physical device in a network. Furthermore, a route is defined as one or more paths for which a demand can take to traverse the network from origination to destination.

In a preferred embodiment, the system would consist of 6 main components:

A Data Collection (DC) engine

An Analysis (AA) engine

A Configuration (CA) engine

A Communication Bus (CB) engine

A Data Store engine (DS), and

A User Interface (UI) engine

All components exchange messages via the Communication Bus engine, which is a fast software data bus with a set of predefined protocols. The Data Collection (DC) Engine interfaces autonomously with outside sources that can be as diverged as the various network components or others data collection mechanisms that the service providers already have in place. The Data Collection collects network traffic data. It also interprets the data collected, corrects and fills in missing data, converts them into the appropriate format to be stored at the Data Store engine, and performs statistical transformation to gauge the trend of the current network and detect congestion. Once a network problem is identified, whether it is network congestion, network failure, or even a problematic network trend, the Data Collection sends a message to invoke the Analysis (AA) engine.

The Analysis Engine then picks up the problem from the Data Store engine. The details of the problem include the status of the current network, the status and routing of the current set of managed traffic, and any constraint imposed by the users or the limitation imposed by the network components. The Analysis Engine then formulates the problem as a set of mathematical equations and solves them to find a new routing solution for the set of traffic under management. The solution is saved in the Data Store for downstream implementation by the Configuration (CA) engine.

The CA picks up the solution from the Data Store and compares it with the current configuration of various network components. It then formulates a strategy for implementing the new solution in the network with minimal disturbance to the traffic flow. The CA can communicate directly with the network components or provides information to other provisioning systems to implement the solution.

The User Interface provides a means for the user to enter user level information into the system and get status and feedback from the system. The UI also include an API for the system to communicate with other systems to gather management information about desirable behavior for the system. Examples of the type of information to be entered or gathered at the UI include:

Definition and identification of managed demands

Automated or manual approval for implementation of solutions

Definition of traffic priorities

Definition of user responsibilities

Thus it is a feature of the present invention to provide a method and system for directly managing and controlling network equipment which activates solutions to achieve the business goals of the service providers.

It is another feature of the present invention to provide conversion of business profiles and objectives into network constraints.

Yet another feature of the present invention is to assist in optimizing the traffic routing based on network constraints to balance the load over the entire network.

Other features of the present invention include providing solutions to: 1.) Network design problems, 2) Network performance problems, 3) Network availability problems, 4) Network Planning problems, and 5) Traffic Engineering problems. An additional feature is assisting business managers in achieving business objectives by solving network problems Other objects, features, and advantages of the present invention will become apparent upon reading the following specification, when taken in conjunction with the drawings and the appended claims.

### BRIEF DESCRIPTION OF THE DRAWINGS

FIG. 1 is a depiction of the real time mode capabilities of the present control and routing system.

FIG. 2 is a depiction of the main system components of the present invention.

FIG. 3 is a depiction of an embodiment of the Operation Model of the present invention.

FIG. 4 is a depiction of an embodiment the process carried out by Data Collection (“DC”) Engine of the present invention.

FIG. 5 is a depiction of an embodiment the process carried out by the Analysis Engine (“AA”) of the present invention.

FIG. 6 is a depiction of an embodiment the process carried out by the Configuration Process (“CA”) of the present invention.

FIG. 7 is a depiction of an exemplary embodiment of a User Interface Process of the present invention.

FIG. 8 is a depiction of an example routing during congestion.

### DETAILED DESCRIPTION OF THE DISCLOSED EMBODIMENT

Referring now to the drawings, in which like numerals indicate like elements throughout the several views, an embodiment of the present invention will be discussed.

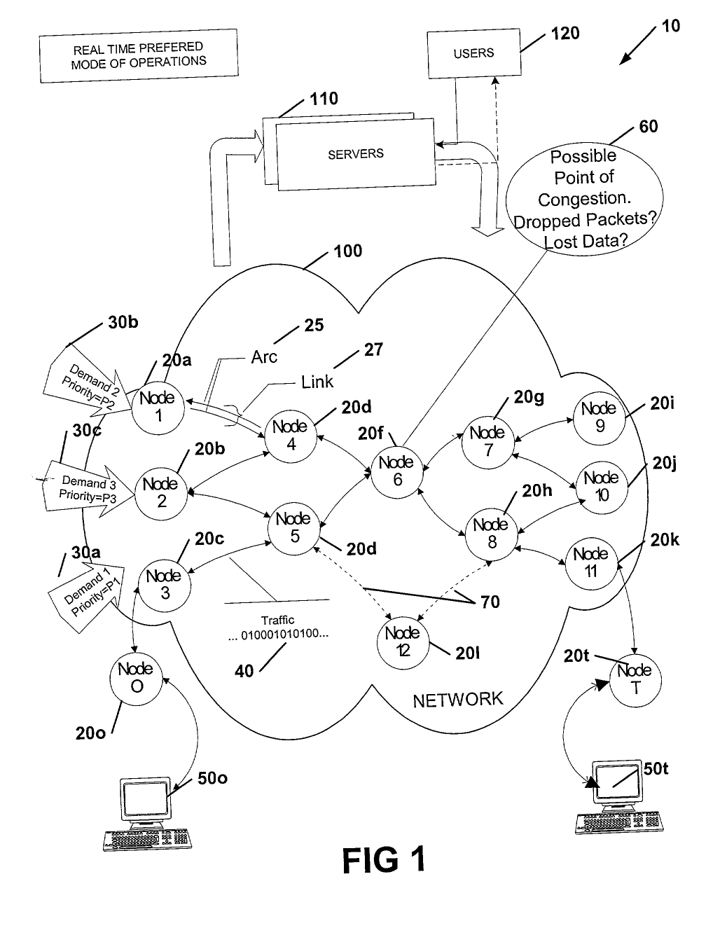

We first turn to FIG. 1, which depicts the real time mode capabilities of the preferred control and routing system 10. FIG. 1 should provide the reader with an overview of the present invention.

System 10 is, generically thought of as one or more network servers 110, system users 120, and network 100. Network servers 110, allows one or more system users 120 to interaction with it. The number of network servers110 typically will depend on the size of network 100 for which it is operatively connected with network 100 and preferably controlling and managing network 100.

Network 100 can be the size of a Local Area Network (“LAN”) to the size of the Internet, or any subset of network sizes between. Preferably, network 100 is the network, or a portion thereof, for which a service provider sells to or provides access to at least one customer.

System users 120 will interact with Network Server 110 as needed, and as discussed subsequently. System user 120 is typically an administrator or a manager of network 100.

Servers 110 are preferably capable of both monitoring and configuring a plurality of Nodes 20a-l that are located in Network 100. By way of example only, and not for purposes of limitation, By way of example only, and not for purposes of limitation, the following definitions are herein defined to aid in a better understanding of the present invention:

A node is a switch, router or other physical device in Network 100. Nodes are operatively connected by an Arc 25.

An Arc 25 a logical one-way connection on a Link 27.

A Link 27 is a physical connection between two physical Nodes 20 in Network 100. In FIG. 1, Links 27 are represented by double arrows within Network 100. However, more than two Arcs 25, may make a Link 27.

A path is a set of connecting Arcs 25 between two Nodes 20 in Network 100.

A Demand 30a-c is a requirement for a certain amount of bandwidth to be reserved between Originating Node 20o and Terminating Node 20t with its performance specification.

Routing is one or more paths that Demand30a-c can take between Originating Node 20o and Terminating Node 20t.

Network components include all physical parts of the network related to traffic including Nodes 20a-l and all Arcs 25 and Links 27.

Congestion 60 is the inability for traffic to traverse Network 100 from Origination Node 20o to Termination Node 20t.

Traffic 40 is bits, bytes, packets, telephone calls, video signals, has at least one origination node 20o and one destination or termination node 20t

As an example, Originating Computer 50o desires to make a data transmission to Terminating Computer50t. To do this Originating Computer 50o, which is operatively connected to Originating Node 20o, sends data which becomes Traffic 40. Traffic 40 has a Demand 30a associated with it. The present invention assigns a Priority Value, P, to the Demand 30.

As shown in the present example, Originating Node 20o is connected to Network 100 via Node 3 20c. Traffic 40 will then pass from Originating Node 20o to Node 3 20c. Then Traffic 40 passes from Node 3 20c to Node 5 20e. Then Traffic 40 passes from Node 5 20e to Node 6 20f. Then Traffic 40 passes from Node 6 20f to Node 8 20h. Then Traffic 40 passes from Node 8 20h to Node 11 20k. Then Traffic 40 passes from Node 11 20k to Terminating Node 20t.

One can appreciate, that in the present example the route for Demand 1 30a is: Node 0 20o to Node 3 20c to Node 5 20e to Node 6 20f to Node 8 20h to Node 11 20k to Node T 20t.

However one can also appreciate that other Traffic 40 and Demands 30b-c are also attempting to utilize the same Nodes 20a-k. For example, Demands 1-3 30a-c may “reach” Node 6 20f at the same moment in time. Node 6 20f maybe incapable of providing for the requirements and needs of Demands 30a-c. Therefore Congestion 60 may exist. Congestion produces a higher likelihood of packets being delayed or even dropped. As discussed above, not all Demands are equal in value to the provider of Network 100.

The “value” of the Demands, in the eyes of User 120, is directly related to the impact fulfilling, or not fulfilling Demand 30 to the overall revenue of Network 100 for User 120 Therefore, the present invention provides User 120 a method to assign a priority value, P, to a customer's demand, based on the customer's attributes and criterion.

This prioritization is discussed in the co-pending application “Behavioral Compiler for Prioritizing Network Traffic Based on Business Attributes” by Nguyen, L et al., Serial No. TBA in greater detail and is hereby incorporated by reference. Provisional patent application for which the aforesaid mentioned patent application claims priority to, Serial No. 60/237,146 is also incorporated by reference.

Based on the assigned priority value, P, of Demand 30a-c, Network 100 will give a greater preference to a Demand 30 with a higher priority assigned to it. For example, assume Demand 1 30a is assigned a priority value P1, and Demand 2 30b is assigned a priority value P2, and Demand 3 30c is assigned a priority value P3.

Now assume the following: P1>P3>P2. Therefore, upon reaching Node 6 20f at the same time, Node 6 20f might not have the resource to serve all three (3) demands at the same time, thereby creating Congestion 60. Upon recognizing this Congestion 60 the servers 110 may create Reroute 70 to reroute some or all Traffic 40 to avoid Node 6 20f to Node 12 201.

Others in the past have attempted to have the router do traffic prioritization. However, this method exhibits considerable weakness. A single router is unable to take into account the “big picture” or take a “global view” of Congestion 60 in Network 100. Specifically, these routers are incapable of being made aware of additional bandwidth available elsewhere. The option left to the router during a period of Congestion60 is to either delay or drop traffic.

One might be able to liken this to traffic a driver experiences during their commute. A single stop light on its own is incapable of determining where to send traffic during periods of congestion. It simply will let traffic pass or delay traffic. However, a traffic monitoring system, including cameras, helicopters and airplanes can take a view on the “big picture” and suggest alternative routes for traffic to take. Similarly, but in a digital environment the present invention reroutes utilizing a system that views all or substantially the network issues in real-time. The present invention simply reroutes traffic around points of congestion.

Therefore, if Congestion 60 is present, Demand 2 30b would be the first demand that System 100 allows to be negatively effected by Congestion 60. Therefore, Demand 3, 30c would be the second negatively effected and Demand 130a would be the last negatively effected.

Additionally, another example is that Network100 may create Reroute 70 to reroute some or all Traffic 40 to avoid Node 6 20f to Node 12 201. One can appreciate that this would change the route of Demand 1 30a, from the route discussed prior to: Node 0 20o to Node 3 20c to Node 5 20e to Node 12 201 to Node 8 20h to Node 11 20k to Node T 20t.

During times of Congestion 60, if Reroute 70 is a “better” route, then Demand 1 30a which has the highest priority value, P, will be given the “first chance” to utilize Reroute 70.

Servers 110 can then evaluate, following Demand 1 30a utilizing Reroute 70, which is the “best route,” the prior route or Reroute 70. Understandably if Reroute 70 is still the best route then Demand 3 30c is rerouted to Reroute 70. However, if the prior route is the “best route” again, following Demand 1 30a utilizing Reroute 70, then Demand 3 30c, having the next highest priority value, P, utilizes the prior route. Finally, Demand 2 30b is similarly evaluated and utilizes the appropriate route.

Furthermore the present invention will preferably account for, in real time, pertinent changes in Network100 and changes to Demand 30a-c priority values, P.

System 10 collects data in real time or near real time from Network 100. Real time or near real time is preferably an immediate or a close to immediate actions with the action being continuously or periodically taken. This is preferably done in an asynchronous matter where possible.

Hereinafter, the meaning of real time will include near real time. System 100 also preferably issues control messages to the equipment of Network 100. When such controls are received by the equipment, the behavior of Network 100 will understandably be changed. Results of such changes are fed back into System 10 for further control as appropriate.

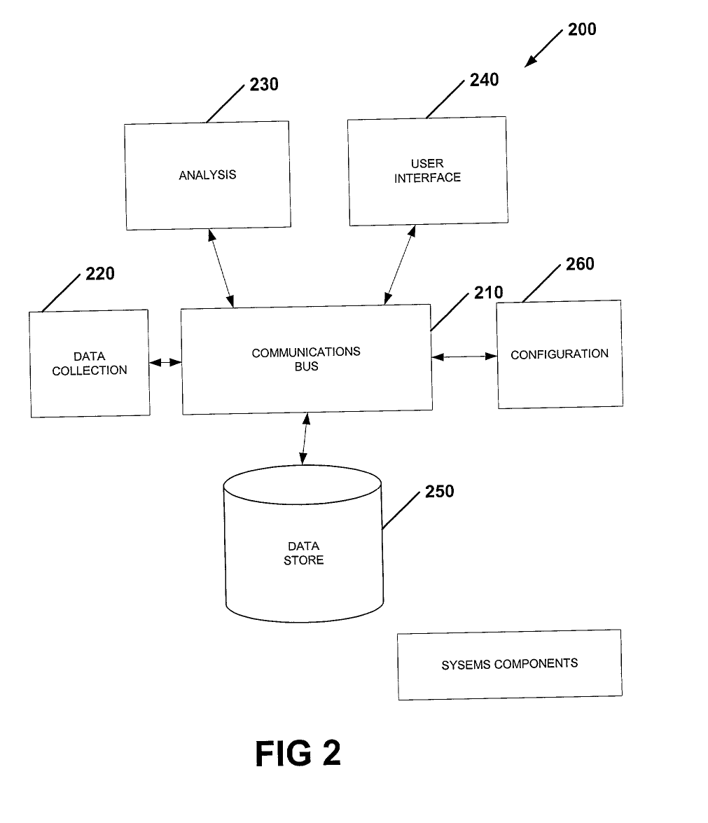

Now let the reader turn to FIG. 2, which depicts an exemplary embodiment of the main system components200. These components include Data Collection Engine 220, Analysis Engine 230, User Interface 240, Data Store 250 and Configuration 260, all of which are preferably operatively connected to Communications Bus 210.

Each of the above components preferably has its own functions and works cooperatively with the other components to achieve the objectives of the system.

Communication Bus (“CB”) 210 serves as a “message board” for all other components to communicate with each other using a predefined protocol. Each component wishing to communicate with one or more of the other components simply “posts” a “message” on Communication Bus 210. All components preferably monitor Communication Bus 210 for relevant messages and act accordingly.

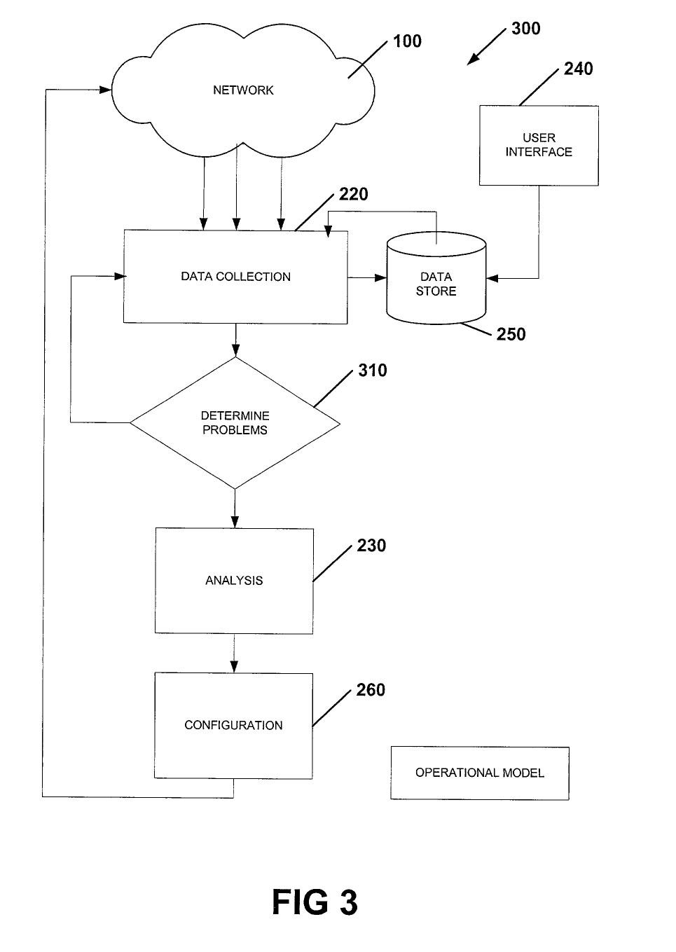

Now let the reader turn to FIG. 3, which depicts an exemplary embodiment of an Operation Model of the System 300. Data Collection Engine 220 receives data from the outside world. This data can be collected via network elements or external systems. Data collected preferably includes network traffic statistics, network faults, and network status changes.

Network traffic statistics preferably include usage on each network interface, on each network element, and on each communication link. As discussed prior, a communication link is a physical connection between two nodes in Network 100. A node is typically a switch, router or similar physical device in Network 100.

Network faults include the up/down indications of network elements and various error conditions of such network elements.

Network status changes include routing changes; deletion, addition, or modification of network elements; and addition, deletion or modifications of managed demands.

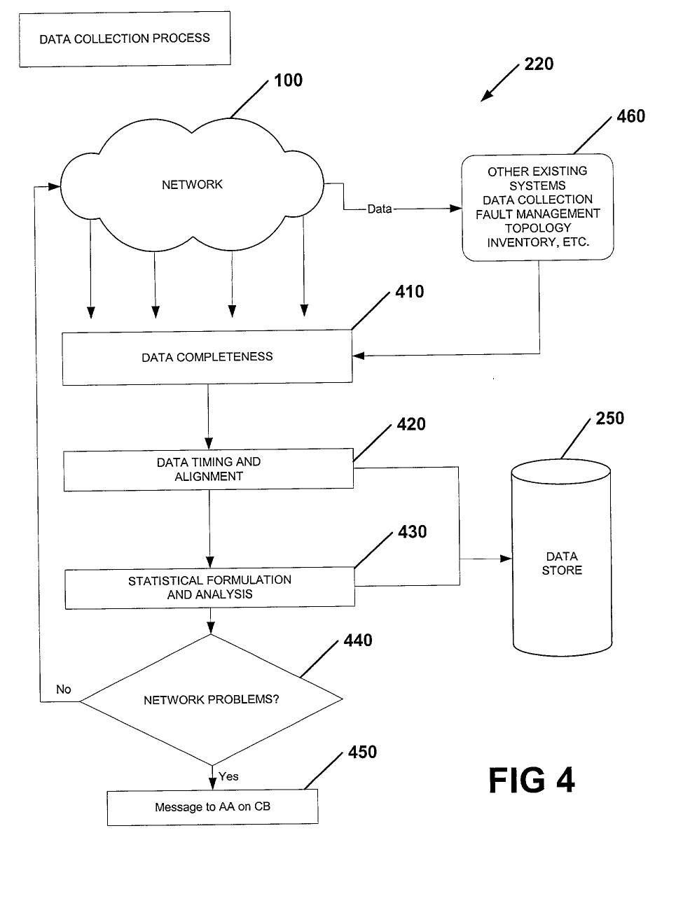

Data collection 220 is discussed subsequent as shown in FIG. 4. The data is then preferably formatted and forwarded to Data Store (“DS”) 250 via Communication Bus 210. The data is then stored for later access in Data Store 250.

Turning to FIG. 4, which depicts the process carried out by Data Collection (“DC”) Engine 220, it is shown that Data Collection 220 collects data from Network 100. Following collection of the data, the next step is reviewing the data for completeness 410. Data might be collected directly from Network 100 or could be collected in addition, or alternatively, from Other Existing Systems 460. These other systems may include other data collection systems, fault management systems, topology data, inventory data and the like.

Data is preferably collected from multiple sources which in turn collect individual pieces of data from thousands of network components. Do to this, not all data is received at the same speed. For example, some data may immediately arrive, and other data my be delay and take several minutes or more to be retrieved. This creates a more and more accurate “picture of the past” until all the data for a certain time instance is collected.

To have a “snap shot” view of the health or status or the network, it is therefore important to “line up” the data in a consistent manner in terms of timing for data collected and received. One skilled in the art will appreciate that the majority of the data is “time stamped” and can be organized based on this time stamp.

Following this, the data is passed to Data Store250 and Data Collection 220 performs the step of statistical formulation and analysis 430 to detect trends, errors and congestion in Network 100. As discussed prior, congestion is the inability for traffic to traverse the network to its intended destination with proper performance. As defined prior, Traffic in the present invention is digital communication which has at least one origination node and one destination node in Network 100. This includes, without limitation, bits, bytes, packets, telephone calls, video signals and the like.

Following this step, Data Collection220 preferably obtains a view of the overall “health” of Network 100 through decision step 440 which has the computer review if there are network problems and data relating to the “health” is passed to Data Store 250. If one or more errors or congestion events are detected, Data Collection 220 records such detections in Data Store 250. Following such detection, a messaging step 450 is performed which sends an activation message to Analysis Engine (“AA”) 230 via Communication Bus 210.

Following step 450 of messaging to Analysis Engine 230 on Communication Bus 210 or if decision step 440 is not fulfilled, the process once again is run. As one can see this process is preferably asynchronous to the other processes and continuous in nature.

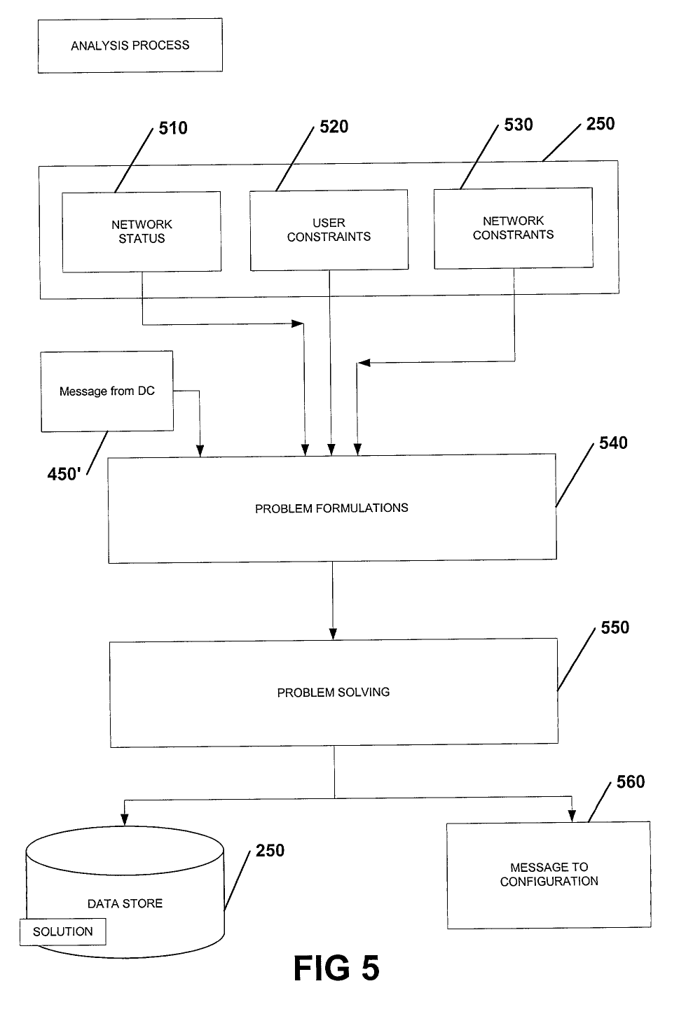

The reader should now turn to FIG. 5, which depicts an embodiment of the Analysis Engine230. Following performance of sending message to Analysis Engine 230 on Communication Bus 450, as shown on FIG. 4, the message is received from Data Collection 220 by Analysis Engine 230 in the first step 450′ of Analysis Engine 230 process, as shown in FIG. 5.

Following, Analysis Engine 230 retrieves data necessary for analysis from Data Store 250. This preferably includes:

Network Status Data 510,

User Constraints 520, and

Network Constraints 530.

Network Constraints 530 includes router constraints, distance constraints, and managed traffic. User Constraints 520 include priority levels for customers, traffic and any user authorization for network configuration.

The retrieved data is used in the next step 540 of problem formulations. This entails the formulation of the routing optimization problem.

The next step is the step of problem solving 550 which formulates an optimized routing solution.

One exemplary embodiment is the following routing formulation: Minimize:

$${\sum }_{uv , i , j} \frac{{C}_{ij}}{{P}^{uv}} {x}_{ij}^{uv} \qquad Eq . 1$$

Subject to:

$$\begin{matrix}{\sum }_{j} {x}_{kj}^{uv} - {\sum }_{i} {x}_{ik}^{uv} ∀ κ ∉ \{ u , v \} , ∀ ( u , v ) & Eq . 2 \\ {\sum }_{j} {x}_{uj}^{uv} ∀ ( u , v ) & Eq . 3 \\ {\sum }_{j} {T}^{uv} * {x}_{ij}^{uv} \leq {B}_{ij} ∀ [ i , j ] & Eq . 4\end{matrix}$$

xᵢⱼ^{uv}=0 or 1 ∀(u,v),∀[i,j] Eq. 5

Where:

(u,v)=demand pair from originating point u to destination point v

[i,j]=arc i,j

Cᵢⱼ=Cost of arc[i,j]

P^{uv}=penalty of demand (u,v)

T^{uv}=bandwidth of demand (u,v)

Bᵢⱼ=bandwidth available on arc [i,j]

xᵢⱼ^{uv}=variable to be solved

The solutions to the formulations will depend on formulation itself. Some formulations might be harder to solver than others. For example the above formulation allows for an Integer Programming solution in a format that one skilled in the art will readily recognize appropriate measures to solve it. Additionally, such software titles asCPlex, Matlab, and the like will assist in providing a solution.

Following this step the data is stored in Data Store 250 and a step of messaging to Configuration Engine 560 is performed. As before the message is placed on Communication Bus 210.

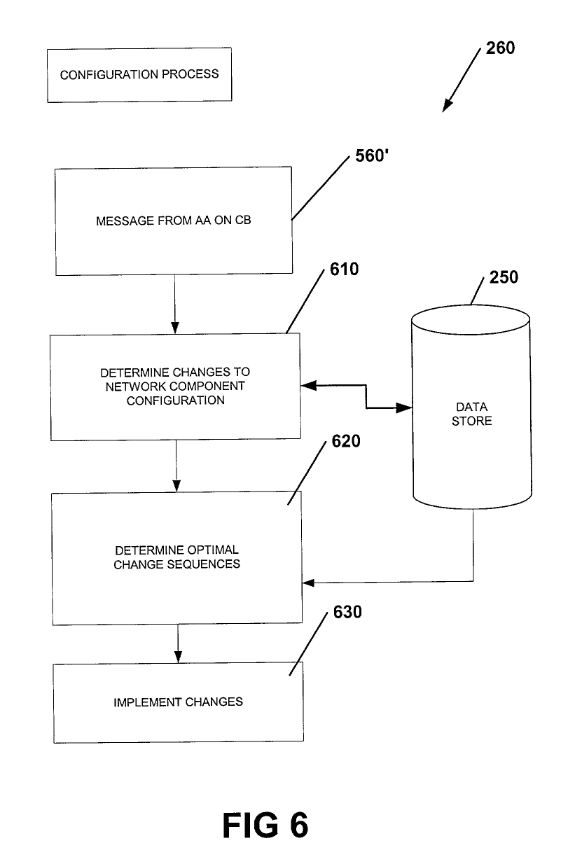

Now the reader should direct their attention to FIG. 6, which depicts Configuration Process 260. Message 560 from Analysis Engine 230 after being places on Communication Bus 210 is able to be viewed by Configuration Process 260. The message is received as Message 560′. Following receipt of Message 560′, the next step 610 is performed and Configuration Engine 260 retrieves both the current solution and the new solution from Data Store 250. Following retrieval of both solutions, a computation of the difference between the two solutions are made in the same step 610

Following this, the next step determines the optimal change sequences 620, which calculates the changes as to ensure minimal impact to existing traffic.

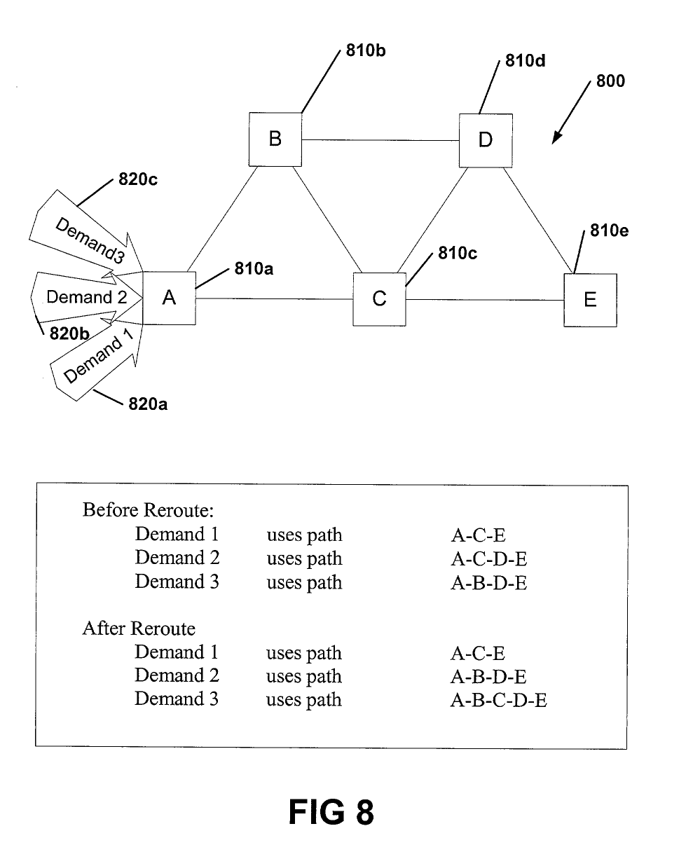

The reader should turn to FIG. 8, which depicts a simplified exemplary embodiment of a routing solution800 in response to Congestion 60.

Assume that there are three (3) demands 1, 2, 3 820a-c, between Node A 810a and Node 810e. Also assume that these demands are being routed as follows:

Before Reroute:

Demand 1 uses path A-C-E

Demand 2 uses path A-C-D-E

Demand 3 uses path A-B-D-E

Suppose that there is a congestion on arc AC 830ac. Now let us assume that the routing solution is determine to be as follows:

Demand 1 uses path A-C-E

Demand 2 uses path A-B-D-E

Demand 3 uses path A-B-C-D-E

The difference between the solution reroute and the original routing shows two changes, that in associated with Demand 2 820b and Demand 3 820c. The routing for Demand 1 820a remains the same. Therefore only two changes must be made to the network routing configuration.

The next step is to determine which of the two (2) changes need to happen first. If Demand 2 820b is rerouted first, then it is possible that it will impact the performance of Demand 3 820c depending on other possible traffic in the network as both Demand 2 820b and Demand 3 820c will share routes.

Therefore it is more efficient and produces less network impact on the network if Demand 3 820c is rerouted first to path A-B-C-D-E. Following Demand 2 820b can be rerouted to path A-B-D-E.

Following this, step 630 of implement changes, Configuration Process 260 makes the changes to the elements in Network 100, to affect the routing of various demands in Network 100.

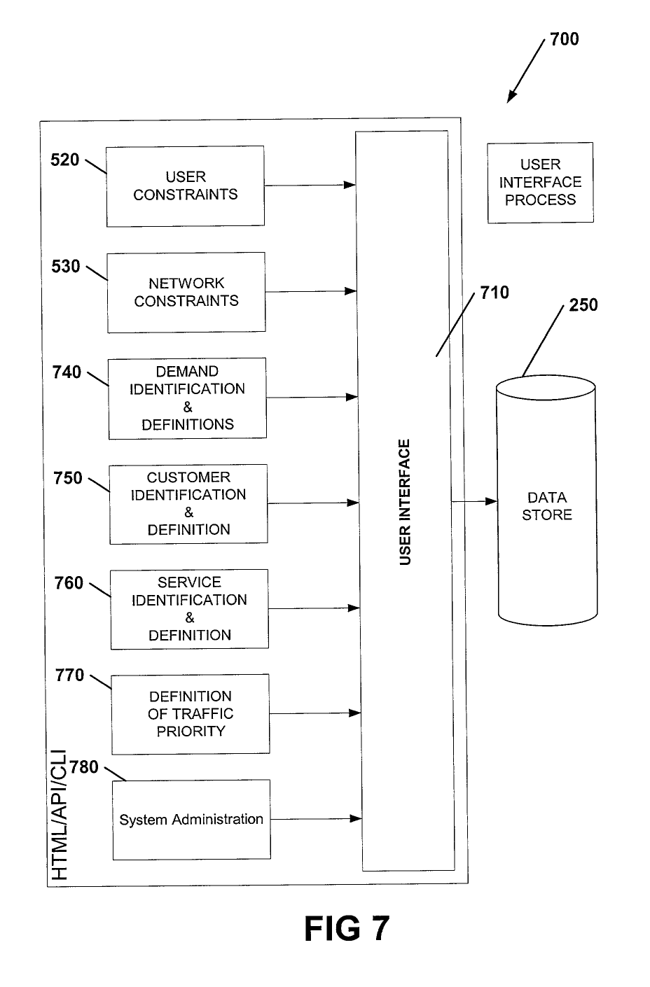

Now turning to FIG. 7, which is a depiction of an exemplary embodiment of a User Interface Process 700 for the present invention, the customer reacts with the system via a User Interface 710 which will allow entry, deletion, and modification of user related data and storage of such user related data in Data Store 250. As one skilled in the art will appreciate, User Interface 710 can take a multitude of forms, including a Web (HTML) interface, a Command Line Interface (CLI), a Graphic User Interface (GUI), or an Application Programming Interface (API).

The main purpose of the User Interface Process 700 is to allow the user to enter into the User Interface 710 constraints of User Constraints 520 and Network Constraints 530 as discussed above. Additionally such other constraints may be entered by the user into the User Interface including System Administration 780, Demand Identification and Definitions740, Customer Identification and Definition 750, Services Identification and Definition 760, and Definition of Traffic Priority 770.

The preceding embodiment is given by way of example only, and not by way of limitation to the invention. The true essence and spirit of this invention are defined in the appended claims, and is not intended that the embodiment of the invention preceding should limit the scope thereof. It will be appreciated that the present invention can take many forms and embodiments. Variations and combinations thereof evident to one skilled in the art will be included within the invention defined by the claims.

What is claimed is:

1. A method for central control and intelligent routing of data network traffic comprising the steps of:
A. Continuously collecting data from the network components;
B. Determining congestions and error conditions;
C. Determining routing solutions to alleviate the problems; and
D. Implementing the solutions by changing the configuration of network components.

2. The method of claim 1 further comprising the step of:
E. Identification of congestion on the links using standard statistical methods and a user defined threshold.

3. The method of claim 1 further comprising the step of:
E. Sequencing of actions to be taken while implementing the solution in the network.

4. The method of claim 1 further comprising the step of:
E. Determination of the solution by changing the routing of one or more demands to alleviate the network problem.

5. A system for central control of routing of a digital network comprising:
A Data Collection engine;
An Analysis engine;
A Configuration engine;
A Communication Bus engine;
A Data Store engine and
A User Interface engine.

6. The system of claim 5 wherein the data collection engine performs the steps of:
collecting network data;
correct and fills missing data, and
convert the data to a format for use by the Data Store Engine.

7. The system of claim 5 wherein the data analysis engine performs the steps of:
retrieve a report of a network problem from the data store engine,
formulates the problem as a set of mathematical equations,
solves the equations, wherein the solution provides a solution for the set of traffic under management.

8. The system of claim 5 wherein the communication bus performs the step of:
allow for message to be posted by an engine to be viewed by another engine.

9. The system of claim 7 wherein the communication bus performs the step of:
allow for message to be posted by an engine to be viewed by another engine.

10. The system of claim 8 wherein the data collection engine performs the steps of:
collecting network data;
correct and fills missing data, and
convert the data to a format for use by the Data Store Engine.

11. A network server for providing routing of a digital network, comprising:
a computer,
wherein the computer is capable of being operatively connected to the network,
wherein the computer is capable of receiving data from a plurality of nodes within the network,
wherein the computer is capable of recognizing network congestions, and
wherein the computer is capable of rerouting traffic.

12. The server of claim 11 wherein the computer is capable of formulating solution of network congestion.

13. The server of claim 12 wherein the computer formulates the solution by minimizing an equation.

14. The server of claim 13 wherein the equation comprises:
$${\sum }_{uv , i , j} \frac{{C}_{ij}}{{P}^{uv}} {x}_{ij}^{uv} ,$$
wherein the equation is subject to the equations comprising:
$$\begin{matrix}{\sum }_{j} {x}_{kj}^{uv} - {\sum }_{i} {x}_{ik}^{uv} ∀ κ ∉ \{ u , v \} , ∀ ( u , v ) \\ {\sum }_{j} {x}_{uj}^{uv} ∀ ( u , v ) \\ {\sum }_{j} {T}^{uv} * {x}_{ij}^{uv} \leq {B}_{ij} ∀ [ i , j ]\end{matrix}$$
xᵢⱼ^{uv}=0 or 1 ∀(u,v),∀[i,j]
Wherein the variable comprise:
(u,v)=demand pair from originating point u to destination point v
[i,j]=arc ij
Cᵢⱼ=Cost of arc[ij]
P^{uv}=penalty of demand (u,v)
T^{uv}=bandwidth of demand (u,v)
B_{i,j}=bandwidth available on arc [i,j]
Xᵢⱼ^{uv}=variable to be solved

15. The server of claim 12 wherein the equation is utilizes a priority value of a network demand based on business attributes and criterions.

16. The server of claim 15, wherein the priority value is calculated by the steps of:
a user selecting from a plurality of business attributes;
the user creating of a defined mathematical formula based on the attributes to calculate relative priorities of demands;
computer automated collection of data related to the current value of the business attributes; and
computer automated calculation of a priority values.
